(19) United States
(12) Patent Application Publication
(10) Pub. No.: US 2020/0242714 A1
(43) Pub. Date: Jul. 30, 2020

(54) CONTEXTUAL AND PROFILE TARGETED CONTENT ANALYSIS AND RECOMMENDATION IN AN ON-DEMAND COMPUTING SERVICES ENVIRONMENT

(71) Applicant: Salesforce.com, Inc., San Francisco, CA (US)

(72) Inventors: Adam McCormick Doti, Petaluma, CA (US); Adam Torman, Walnut Creek, CA (US); Samantha Ready, San Francisco, CA (US)

(73) Assignee: Salesforce.com, Inc., San Francisco, CA (US)

(21) Appl. No.: 16/258,900

(22) Filed: Jan. 28, 2019

(51) Int. Cl. G06Q 50/20; H04L 12/24; G06Q 10/06; H04L 29/08

(52) U.S. Cl. CPC G06Q 50/2057; H04L 41/5051; H04L 41/5064; H04L 67/42; H04L 67/306; H04L 67/22; G06Q 10/06398

(57) ABSTRACT

An on-demand computing services environment provides computing services to clients via the Internet. The on-demand computing services environment may be associated with skills that each identify the use of a one or more features of the environment. Skill ratings associated with one or more of the skills may be identified for a user account. A recommendation profile for the user account may be determined based on the designated skill ratings and a skill graph indicating dependency relationships between the skills. The recommendation profile may identify one or more training modules to be completed in association with the user account. A recommendation message including one or more recommendations selected from the recommendation profile may be transmitted to the client machine.

### COPYRIGHT NOTICE

A portion of the disclosure of this patent document contains material which is subject to copyright protection. The copyright owner has no objection to the facsimile reproduction by anyone of the patent document or the patent disclosure as it appears in the United States Patent and Trademark Office patent file or records but otherwise reserves all copyright rights whatsoever

### FIELD OF TECHNOLOGY

This patent document relates generally to on-demand computing services systems such as database systems and more specifically to guiding interactions with on-demand computing services system.

### BACKGROUND

“Cloud computing” services provide shared resources, applications, and information to computers and other devices upon request. In cloud computing environments, services can be provided by one or more servers accessible over the Internet rather than installing software locally on in-house computer systems. Users can interact with cloud computing services to undertake a wide range of tasks.

A computing services environment often provides a variety of computing services to many different entities such as companies, company divisions, or service units of the computing services environment itself. Each of these entities may in turn provide access to the computing services environment for potentially many different users. A user often authenticates to the computing services environment when accessing services provided via the computing services environment. In many configurations, an entity authorizes the creation of a digital identity within the cloud computing environment for a user associated with the entity. The entity may also assist in managing that digital identity, which may include information such as the user's role within or relationship to the entity.

### BRIEF DESCRIPTION OF THE DRAWINGS

The included drawings are for illustrative purposes and serve only to provide examples of possible structures and operations for the disclosed inventive systems, apparatus, methods and computer program products for contextual and profile targeted content analysis and recommendation, These drawings in no way limit any changes in form and detail that may be made by one skilled in the art without departing from the spirit and scope of the disclosed implementations.

FIG. 1 illustrates an example of an overview method, performed in accordance with one or more embodiments.

FIG. 2 illustrates an example of an arrangement of skills and experience in a skills and experience repository in an on-demand computing services environment, configured in accordance with one or more embodiments.

FIG. 3 illustrates an example of an arrangement of skills and roles in an on-demand computing services environment, configured in accordance with one or more embodiments.

FIG. 4 illustrates an example of a method for skills detection, performed in accordance with one or more embodiments.

FIG. 5 illustrates an example of a method for training module recommendation, performed in accordance with one or more embodiments.

FIG. 6 illustrates one example of a computing device, configured in accordance with one or more embodiments.

FIG. 7 shows a block diagram of an example of an environment that includes an on-demand database service configured in accordance with some implementations.

FIG. 8A shows a system diagram of an example of architectural components of an on-demand database service environment, configured in accordance with some implementations.

FIG. 8B shows a system diagram further illustrating an example of architectural components of an on-demand database service environment, in accordance with some implementations.

FIGS. 9-12 illustrate examples of user interfaces that may be generated in accordance with one or more embodiments.

### DETAILED DESCRIPTION

The variety and complexity of services provided by many computing services environments means that considerable experience and skill is often required for proficient use. The computing services platform may provide a variety of training tools to help educate users about the features available on the system. However, users may be uncertain about how best to direct their learning efforts. Such uncertainty creates a technological challenge for the provider of the computing services system since manual identification of skill gaps and recommendation of training modules would likely suffer from uneven application and would require substantial expenditure of resources.

According to various embodiments, techniques and mechanisms described herein facilitate the identification and recommendation of training modules to improve user interactions with on-demand computing services environments such as database systems. In some instances, training modules may include explicit training programs such as coursework or certification classes that are separate from a user's day-to-day activities on the system. Alternately, or additionally, training modules may include expansions to or variations on activities undertaken as part of a user's organizational responsibilities.

In some implementations, the usage of an on-demand computing services environment may implicate many different types and levels of skills. For example, a user may develop skills related to services such as customer relations management, inter-organizational communications, customer service management, databases, programming languages, and application customization. As another example, a user may be trained in the application, auditing, administration, or provisioning of such services. All of these services and roles may be associated with skills. Different roles and services may have distinct or overlapping skill sets. In addition, skills may exhibit dependency relationships, where the learning of a more advanced skill requires first learning a less advanced skill.

Consider the situation of Alexandra, a user of customer relations management (CRM) services provided via an on-demand computing services system. Over time, Alexandra has become proficient in using CRM services in her role within an organization that is a client of the on-demand computing services provider. To advance in her career, Alexandra would like to transition to a new organizational role that requires administration of CRM services and supervision of CRM practitioners such as herself. However, in her current position Alexandra is not exposed to the information needed to learn these skills, and she is unsure how best to proceed.

According to various embodiments, techniques and mechanisms described herein facilitate the automatic recommendation to Alexandra of new training modules to complete in order to make this transition, The system identifies and evaluates Alexandra's current skill set based on information such as her resume, service usage, certifications, and existing organizational role. The system then identifies and suggests to Alexandra steps that she may take in order to advance in her understanding and ability within the services provided via the on-demand computing services environment, Such recommendation can proceed accurately and automatically, without costly and inaccurate manual evaluation of Alexandra's skill set.

In some implementations, content and tools may be recommended to users by a recommendation engine driven by our skill graphs. Skill graphs may be constructed by analyzing activities associated with a user account across a variety of products, training tools, training content, and engagement behavior records. For example, recommendations about training tools may reflect not only past training or certification programs within the system, but also a user's day-to-day activities within the on-demand computing services environment performed in the service of their organization role.

In some embodiments, skill gaps can be automatically identified for a user. A user may then be automatically presented with recommendations of content to fill these gaps and to elevate learning/skill to the next level. This experience can be round-tripped back into the products via user engagement mechanisms. These recommendation mechanisms can be presented to users in a variety of ways. For example, a user may be presented with recommendations via user interfaces such as a personalized, intelligent learning component referred to as a “pocket guide”, As another example, a user may be presented with recommendations via user interfaces such as a notification tray, contextual alert bubbles, or help menu content that can deliver personalized content to users in an application used to access the on-demand computing services environment.

In some implementations, a skills values for a user may be determined based at least in part on observed activity because a user is provided with a consistent digital identity across both training activities and work-related activities, potentially for many different organizations or entities. That is, a user may be associated with a global identity, even as the user moves between different entities or organizations within the on-demand computing services environment. Such an identity may be maintained even though the user's permissions and access to data within the system may be specific to the entity or organization.

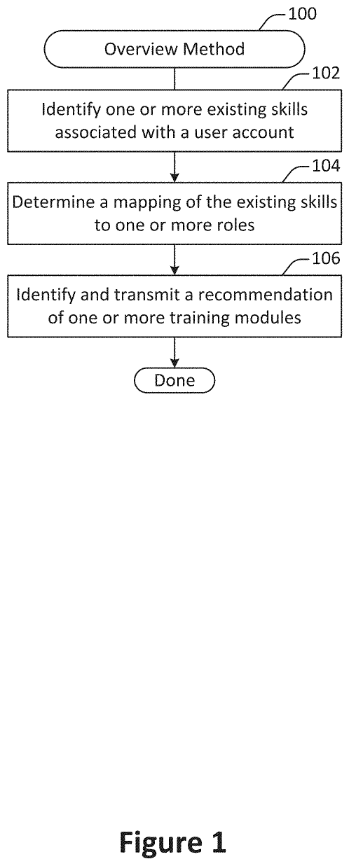

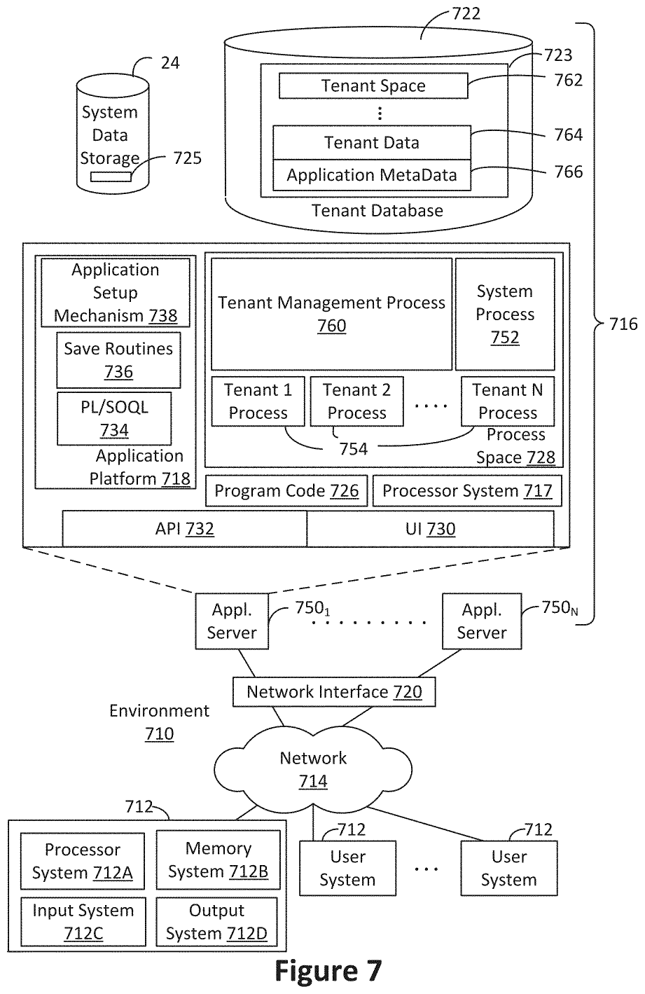

FIG. 1 illustrates an example of an overview method 100, performed in accordance with one or more embodiments. According to various embodiments, the method 100 may be performed at a component of an on-demand computing services environment such as an application server. The application server may be in communication with a client machine. Examples of components included in on-demand computing services environments are discussed in additional detail with respect to FIGS. 7-9.

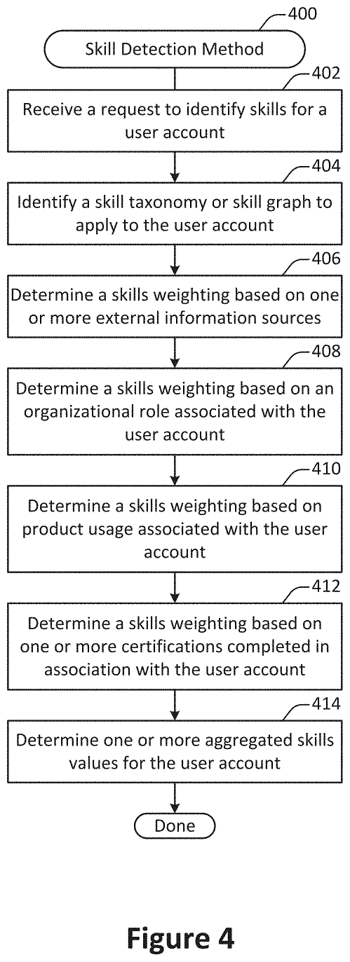

At 102, one or more existing skills associated with a user account are identified. In some implementations, existing skills may be identified via any of a variety of suitable approaches. For example, skills may be identified by processing one or more information sources external to the on-demand computing services environment, such as a resume or a professional networking website such as LinkedIn.com. As another example, skills may be identified based on one or more certifications completed in association with a user account. As yet another example, skills may be identified based on computing services environment product usage associated with the user account. As still another example, skills may be identified based on one or more organizational roles associated with a user account. Techniques for identifying skills are discussed throughout the application, for example with respect to the method 400 shown in FIG. 4.

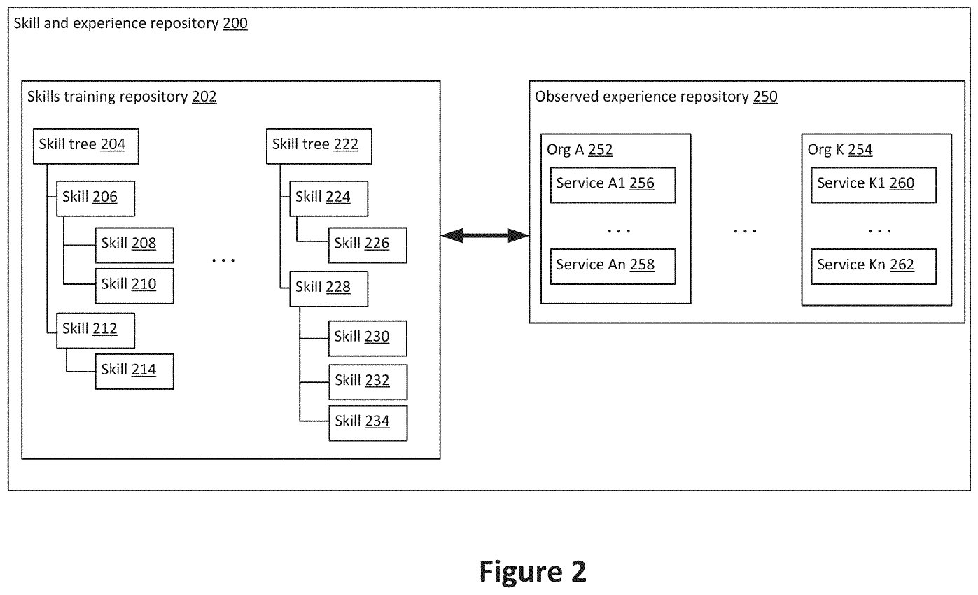

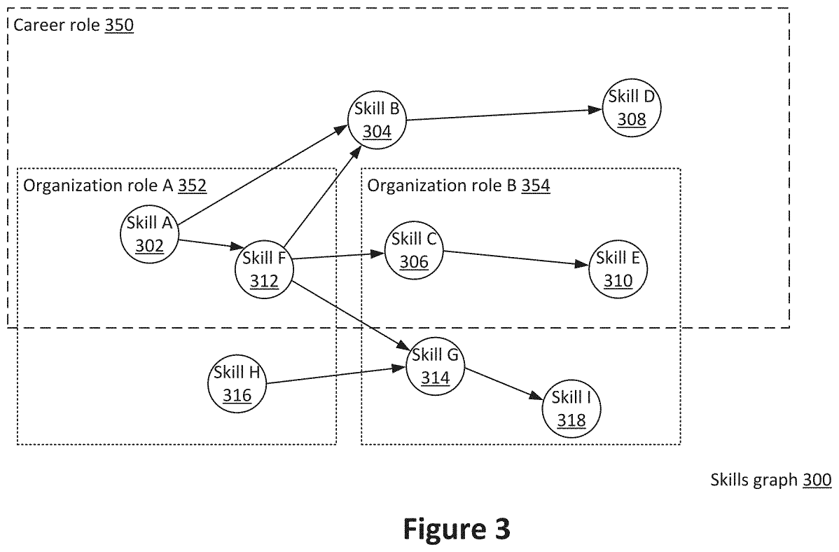

At 104, a mapping of the identified skills to one or more roles is determined. According to various embodiments, the identified skills may be mapped to one or more roles based on a skills graph such as the graph shown in FIG. 3. A skills graph may be constructed based on information such as an experience record or skills training hierarchy as shown in the skills repository illustrated in FIG. 2. Mapping a user's skills may involve operations such as identifying skills typically associated with particular roles within the system and then comparing a user's existing skills to those role-based skill profiles.

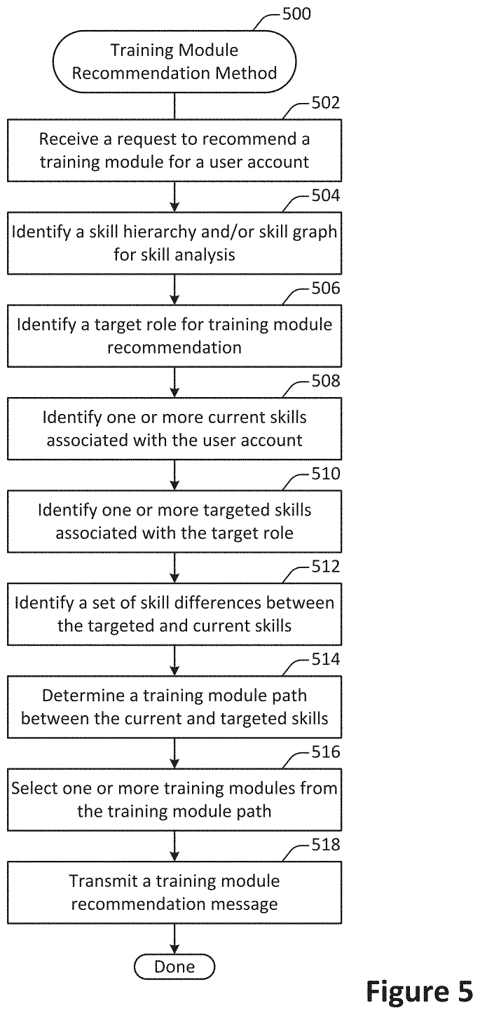

At 106, a recommendation of one or more new training modules is identified and transmitted. In some embodiments, a target role may be identified for training module recommendation. For example, the existing skills associated with a user account may position the user as a practitioner of customer relations management services within the on-demand computing services environment. However, the system may determine that the user could transition to an administrator role that requires additional sophistication with the system. The system may then determine a skills gap between the requirements for the administrator role and the existing skills associated with the user account. The skills gap may then be used to identify one or more training modules to dose the skills gap. Additional details regarding such techniques are discussed throughout the application, and more specifically with respect to the method 500 shown in FIG. 5.

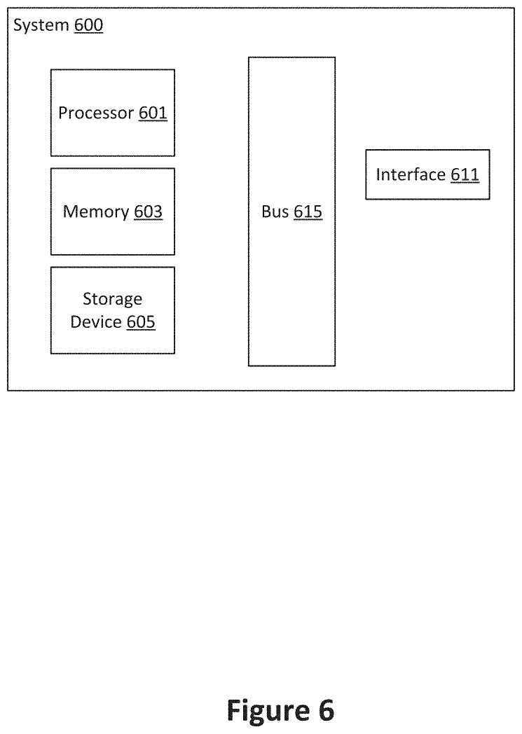

In some implementations, training modules may be identified by identifying new skills that represent a logical extension from the existing skills, and then identifying training modules that facilitate the learning of those new skills. For example, the system may determine a skills graph that identifies dependency relationships between skills. The system may then identify new skills that depend only on the user's existing skills. The system may then select from among the identified new skills, for example by selecting the most advanced new skills that are supported or the skills that are the most related to the user's existing skill set. The identified new skills may then be used to identify one or more training modules to pursue. Additional details regarding such techniques are discussed throughout the application, and more specifically with respect to the method 600 shown in FIG. 6.

FIG. 2 illustrates an example of an arrangement of skills and experience in a skills and experience repository 200 in an on-demand computing services environment, configured in accordance with one or more embodiments. The repository 200 includes the skills training repository 202 and the observed experience repository 250. The skills training repository 202 includes a skills hierarchy that contains skill trees such as the trees 204 and 222. Each skill tree contains a hierarchy of various skills such as the skills 206-214 and the skills 224-234. The experience repository 250 includes a number of organizations such as the organizations A 252 through K 254. Each organization includes one or more of the services provided via the on-demand computing services environment, such as the services 256-262.

According to various embodiments, each skill tree represents a hierarchy of skills related to a particular topic. For example, the skill tree 204 may correspond to a customer relations management service, while the skill tree 222 may correspond with database management. Within this example, the skill 228 may correspond with database architecture, while the skills 230-234 correspond with various aspects of database design such as index specification and field naming conventions.

In some implementations, the observed experience repository 250 identifies different types of experience that can be acquired by performing actions within the on-demand computing services environment. For example, a user may acquire observed experience as part of the user's day-to-day responsibilities within an employment role associated with an organization that is a customer of the on-demand computing services environment.

In some implementations, a user account may be associated with a proficiency or experience level in one or more of the skills or services shown. For example, a user may be assigned a binary value for a skill or experience level, indicating that the user either has or does not have the skill or experience, As another example, a user may be assigned a categorical or continuous value for a skill or experience, indicating that the user has a designated level of experience.

According to various embodiments, skills and experience level may be determined in any of a variety of ways. For example, a designated level of proficiency in a skill or service may be acquired by passing an examination. As another example, a designated level of proficiency may be acquired by taking a training course. As yet another example, a designated level of proficiency may be acquired by performing actions within the on-demand computing services environment, such as opening accounts and editing data.

FIG. 3 illustrates an example of a skills graph 300 depicting an arrangement of skills in an on-demand computing services environment, configured in accordance with one or more embodiments. The skills graph 300 includes the skills 302-18. Organization role A 352, organization role B 354, and career role 350 represent logical groupings of skills. According to various embodiments, a skill may be any ability to perform an action or activity within the on-demand computing services environment. In some embodiments, a skill may be a technical ability, For example, a skill may be an ability to program in a particular programming language at a designated level of proficiency. As another example, a skill may be an ability to create a database schema. As yet another example, a skill may be an ability to create and remove user accounts within a service or organization.

In some implementations, a skill may be a managerial or practical ability, For example, a skill may be an ability to supervise users of a CRM system. As another example, a skill may be an ability to resolve customer technical support questions of a designated type or at a designated level of proficiency. As yet another example, a skill may be an ability to create new customer accounts within a CRM system.

In some embodiments, a skill may be an experience. For example, a skill may be the opening of a designated number of user accounts. As another example, a skill may be the management of a designated number of subordinates within the on-demand computing services environment. As yet another example, a skill may be a designated number of years of experience with a particular technology.

In some implementations, skills may exhibit dependency relationships. For example, in the skill graph 300, learning the skill G 314 may require first learning the skill H 316 and the skill F 312, which in turn may require first learning the skill A 302.

In some embodiments, dependency relationships may be used to facilitate the recommendation of training modules. For example, a user wishing to learn the skill D 308 but current possessing only the skill A 302 may be recommended to first learn the skill B 304.

In some embodiments, dependency relationships may be used to infer knowledge of particular skills. For example, a user known to possess the skill B 304 may be inferred to also possess the skills A 302 and F 312.

According to various embodiments, an organizational role may correspond to a set of responsibilities associated with a user's employment in an organization that is a client of the on-demand computing services environment. For example, the organization role A 352 may correspond to a user of CRM services within the system, while the organization role B 354 may correspond to a supervisor of such users. In this example, the skills A 302, F 312, and H 316 may correspond with abilities such as opening and closing customer accounts, elevating customer concerns to appropriate responders, and editing customer information. The skills C 306, E 310, G 314, and 1318 may correspond with abilities such as reviewing customer support representative performance, responding to elevated customer concerns, and approving CRM-related actions performed within the system.

In some implementations, an organizational role may correspond to a functional activity. For example, the career role 350 may correspond with a logical progression of skills related to CRM-related actions. The skills included within the role 350 may include skills associated with the performance, management, and administration of CRM-related activities. For example, a user may progress within the career role 350 from a CRM user to a CRM supervisor and/or a CRM administrator.

FIG. 4 illustrates an example of a method 400 for skills detection, performed in accordance with one or more embodiments. According to various embodiments, the method 400 may be performed at a component of an on-demand computing services environment such as an application server. The application server may be in communication with a client machine.

A request to identify skills for a user account is received at 402. In some implementations, the request to identify skills may be generated based on user input. For example, a user may activate a button or other affordance in a user interface indicating a desire to receive a training recommendation.

In some embodiments, the request to identify skills may be generated at least in part automatically or periodically. For example, the skills associated with a user account may be identified on a periodic basis, such as once per day or once per month. As another example, the identification of skills associated with a user account may be triggered by a determination that the user account has exceeded a designated activity threshold.

One or more skill taxonomies or skill graphs to apply to the user account are identified at 404. In some implementations, at least a portion of a skill taxonomy or skill graph may be generic to the computing services environment. For example, each user in the computing services environment may be associated with a skill or experience level in each of a set of skills.

In some embodiments, at least a portion of a skill taxonomy or skill graph may be specific to an organization or other entity. For example, an entity may be configured to access a particular set of services provided by the on-demand computing services environment. In such situations, the skills available to users associated with the entity may be limited to those services. As another example, an entity may be associated with one or more skills that are specific to an organizational role or roles associated with the entity.

The determination of skills weightings is discussed with respect to the operations 408-412. According to various embodiments, a skills weighting may be a value associated with a skill. For example, a user may possess or not possess the skill of “JavaScript development.” As another example, a user may be associated with a skill level of between one and five for the skill of “customer relations experience.” As yet another example, a user may be associated with a continuous value skill level for the skill of “time spent using the on-demand computing services system.”

At 406, a skills weighting is determined based on one or more external sources of information, According to various embodiments, such external sources may be any suitable publicly or privately available information that may shed light on a user's skills within the computing services environment. For example, the user's resume may be identified and parsed to identify skills such as managerial experience, knowledge of programming languages, or facility with database systems.

In some implementations, determining a skills weighting associated with a user account may involve accessing a social media account associated with the user account. For example, a user's LinkedIn© profile may be accessed to identify information such as skills listed by the user and confirmed by other users within the system.

At 408, a skills weighting is determined based on an organization role associated with the user account. According to various embodiments, a user may be associated with a role such as a customer service administrator, database architect, or application developer. Such roles may be associated with specific skills. For example, an application developer role may be associated with skills in development via one or more programming languages, with skills in database usage, and with skills in system resource management. As another example, a customer service administrator role may be associated with skills such as customer interaction, account creation and deletion, and account record editing.

In some embodiments, the linkage of roles with skills may be either explicit, implicit, or both. For example, an administrator may explicitly link a role with specific skills. As another example, the system may determine that users associated with a particular administrative role are highly likely to possess at least a designated ability level in a particular skill.

At 410, a skills weighting is determined based on product usage associated with the user account. In some implementations, a user may use various aspects of the on-demand computing services environment as part of the user's day-to-day activities working for one or more clients of the on-demand computing services environment. For example, a user may access records, update records, create records, or delete records in a database system such as a multitenant database. As another example, a user may manage other users performing such tasks. Such activities may be recorded and then used to determine whether a user possesses a particular skill, such as database administration.

In some embodiments, the linkage of activities with skills may be either explicit, implicit, or both. For example, an administrator may explicitly link an activity with one or more specific skills. As another example, the system may determine that users who perform a designated action with a designated regularity level or a designated number of times are highly likely to possess at least a designated ability level in a particular skill. For instance, the system may determine that users who regularly perform a particular action tend to easily pass an examination for a designated skill.

At 412, a skills weighting is determined based on one or more certifications completed in association with the user account. According to various embodiments, certifications may include guided training courses, graded examinations accessible via the on-demand computing services environment, in-person instructional courses, guided actions within the on-demand computing services environment, or other such actions.

In some embodiments, the linkage of certifications with skills may be either explicit, implicit, or both. For example, an administrator may explicitly link a certification activity with one or more specific skills. As another example, the system may determine that users who meet a designated certification requirement are highly likely to possess at least a designated ability level in a particular skill. For instance, the system may determine that users who pass a designated certification tend to regularly perform a particular action within the computing services environment without problems.

At 414, one or more aggregated skills values is determined for the user account. According to various embodiments, an aggregated skills value may combine one or more of the skills weightings determined in operations 406-412. Depending on factors such as the particular skill value being determined, the skill weighting being aggregated, and the certainty with which the skill weighting is estimated, various types of aggregation approaches may be used. For example, an aggregated skill level may be calculated as a minimum, maximum, mean, or weighted average of the skills weightings determined in operations 406-412.

In particular embodiments, one or more of the operations shown in FIG. 4 may be performed in an order different than that shown. Alternately, or additionally, one or more of the operations shown in FIG. 4 may be omitted. For example, a user account may not be associated with a social media account or other external source of information. In this case, operation 406 may be omitted. As another example, a user account may not be associated with any completed certifications. In this case, operation 412 may be omitted.

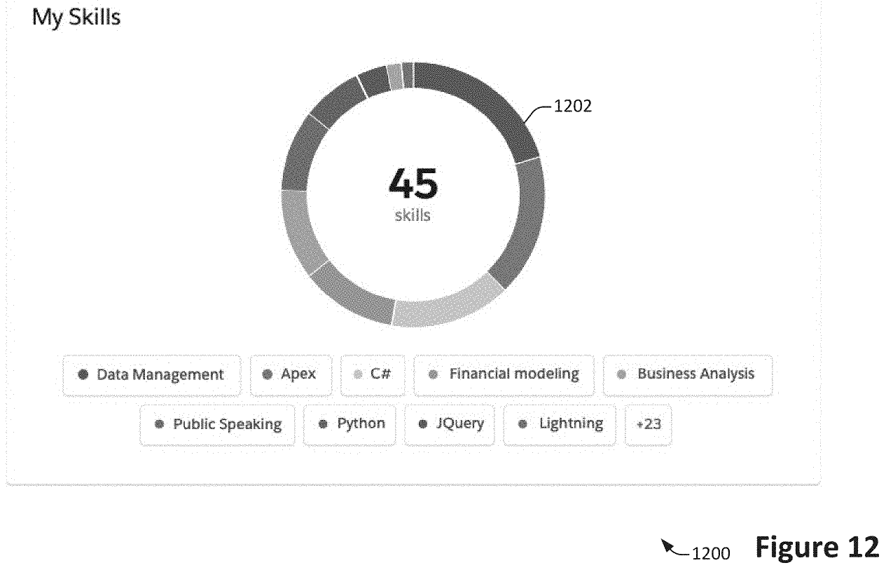

In some embodiments, the skills identified in the method 400 may be presented in a user interface. For example, FIG. 12 illustrates a user interface 1200 that displays a distribution plot 1202 of skills for a user by skill type. The user whose skills are reflected in FIG. 12 has demonstrated some proficiency in 4 different skills, with the majority being in Data Management, Apex, and C#.

FIG. 5 illustrates an example of a method 500 for training module recommendation, performed in accordance with one or more embodiments. According to various embodiments, the method 500 may be performed at a component of an on-demand computing services environment such as an application server. The application server may be in communication with a client machine.

At 502, a request is received to recommend a training module for a user account. In some implementations, the request may be generated periodically. For example, after a user account is created, the user account may be analyzed for training module recommendation in accordance with a designated time schedule, such as at a frequency of once per month or once per week.

In some embodiments, the request may be generated manually. For example, a user such as the user associated with the user account or a systems administrator may manually generate a request for the system to analyze the user account to recommend one or more training modules.

In some implementations, the request may be generated based on the detection of a triggering condition. For example, the request may be generated when the user account meets a designated threshold level of activity. As another example, the request may be generated when the user changes professional roles or indicates a desire to pursue a new professional objective.

A skill hierarchy and/or skill graph is identified at 504. According to various embodiments, the skill hierarchy and/or skill graph may be generic to the on-demand computing services environment. Alternately, or additionally, an organization may be associated with one or more custom skill hierarchies or skill graphs. Such customized skill sets may be identified by using an organization identifier associated with the user account.

A target role for training module recommendation is identified at 506. According to various embodiments, a target role may be any suitable combination of professional responsibilities or abilities within the computing services environment. For example, a target role may be a CRM administrator, a database architect, an application developer, an organization administrator, or a sales team supervisor.

In some implementations, a target role may be identified based on user input. For example, a user may indicate a specific role that the user would like to pursue. Such a selection may be made, for instance, by indicating an item in a list or clicking on a link associated with a target role.

In particular embodiments, a target role may be identified automatically, for instance based on a user's current skill set. In such a configuration, the target role may be identified after the identification of the user's current skills at operation 508. For example, a user's current skill set may be analyzed in comparison with a skill graph to identify a set of skills that are reachable from the current skills. Then, a target role may be identified based on the set of reachable skills.

One or more current skills associated with the user account are identified at 508. According to various embodiments, the user's current skills may be identified via techniques such as those discussed with respect to the method 400 shown in FIG. 4. In some configurations, the user's current skills may be identified in real time during the execution of the method 500. Alternately, or additionally, current skills may be identified at an earlier point in time and stored in a database for retrieval at 508.

One or more targeted skills associated with the target role are identified at 510. In some implementations, the targeted skills may be identified by accessing the skill hierarchy and/or skill graph identified at 504 using an identifier associated with the target role. For example, as shown in FIG. 3, a target role such as a career role 350 or an organization role 352 may be associated with a set of skills included within a skill graph. As another example, the skills in the skills training repository 202 shown in FIG. 2 may be associated with tags or other indicators linking them with specific roles.

A set of skill differences between the targeted skills and the current skills are identified at 512. In some implementations, the current skill values may be subtracted from the targeted skill values to determine a set of skill value differences. The skill values having a positive skill value difference level may then represent those in which the user must increase skill level in order to be qualified for the target role identified at 506.

At 514, a training module path is determined. According to various embodiments, the training module path may include one or more training modules selected to increase the user's skills such that the user may move from the current set of skills to the targeted set of skills. For example, the skills associated with skill differences identified at 512 may be used to query a training module database such as the skills training repository shown in FIG. 2,

According to various embodiments, the training modules may include any suitable mechanisms for improving skills, For example, a training module may include an interactive educational process that a user may access via the on-demand computing services environment. As another example, a training module may include one or more tasks to perform within the on-demand computing services environment as part of the user's normal responsibilities. As yet another example, a training module may include a digital examination accessible via the on-demand computing services environment that tests a user's comprehension regarding a designated skill or skills.

At 516, one or more training modules are selected from the training module path. In some implementations, the one or more training modules may be selected based at least in part on dependency relationships reflected within the skill graph and/or training module path. For example, the skills associated with a positive skill value difference may be identified on a skill graph, The skill graph may include a plurality of dependency relationships, which may reveal that the user account is qualified to pursue training modules for one subset of the skills having a positive skill value difference level but is not qualified to pursue training modules for another subset of those skills.

A training module recommendation message is transmitted at 518, In some embodiments, the message may be transmitted to a client machine. For example, the message may include an instruction to present a recommendation in a user interface. The recommendation may include one or more training modules selected from the training module path determined at operation 514.

In some implementations, the message may be transmitted to a database system. For example, the message may include instructions to store information such as the training module path. Then, the user may be presented with one or more recommendations during future access to the system without needing to re-run the analysis discussed with respect to the method 500,

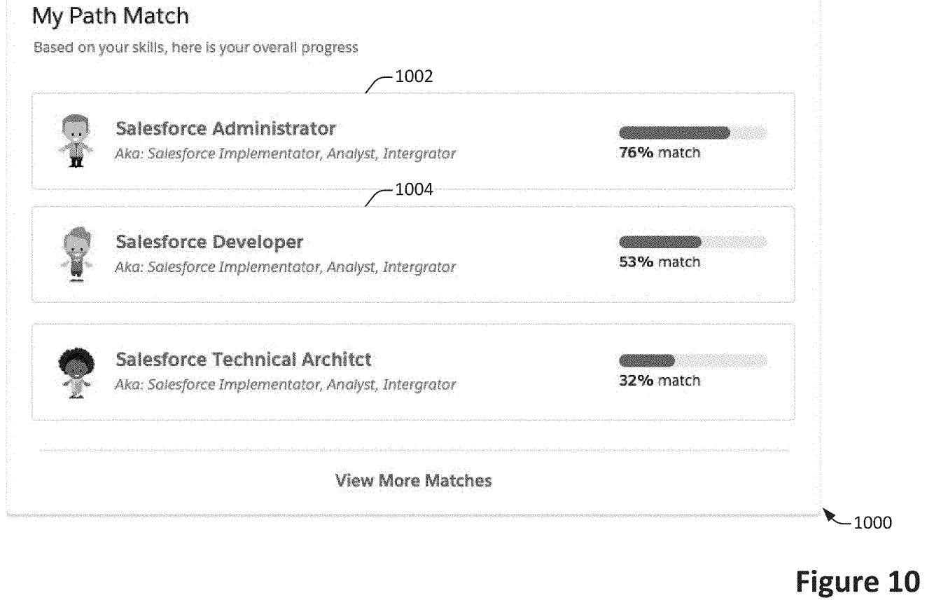

In some embodiments, a training module recommendation message may include one or more recommendations regarding a target role, FIG. 10 illustrates an example of a user interface 1000 for presenting such a recommendation, provided in accordance with one or more implementations, Based on the user's detected skills, the user is a 76% match for a Salesforce Administrator role, while only being a 53% match for a Salesforce Developer role.

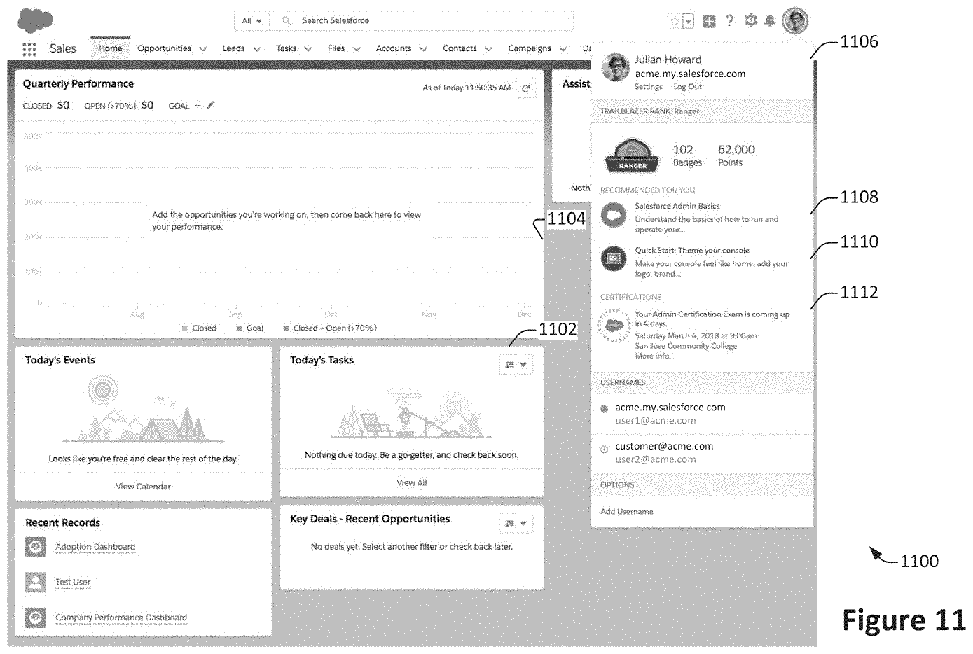

In some embodiments, the training module recommendation message may include one or more instructions for providing a user interface that serves as a window onto a user's skills and training modules. FIG. 11 illustrates an example of a user interface 1100 for accessing to a user's skills and training modules, generated in accordance with one or more implementations. The tasks window 1102 lists tasks that the user may need to complete as part of the user's professional responsibilities. The quarterly performance window 1104 may track the user's performance in the user's job, showing information such as sales contracts closed. The skills overlay window 1106 may provide information about the user's current skills and training module recommendations. For example, in the skills overlay window 1106, the user has been awarded the rank of “Ranger” within the task management system based on the user's detected skills. The skills overlay window 1106 also includes recommend training modules such as the Salesforce Admin Basics module 1108 and recommend actions within the system such as “Quick Start: Theme your console” at 1110. In addition, the skills overlay window includes a recommend certification at 1112.

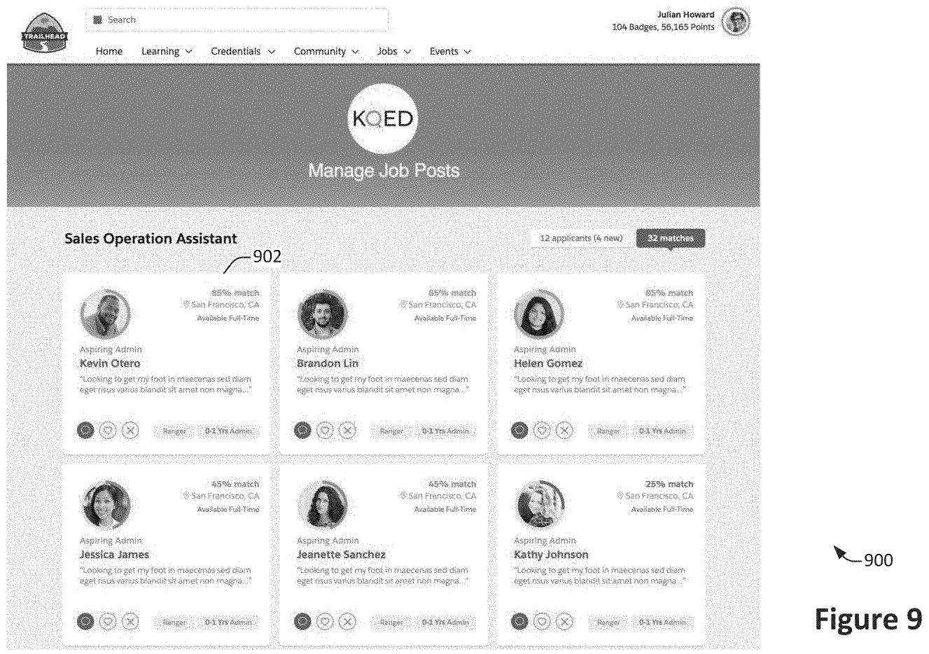

In some embodiments, the method 500 may be used to identify users to meet an employment need. For example, FIG. 9 illustrates a user interface 900 that may be generated in accordance with one or more embodiments. The user interface 900 is displaying candidates for a Sales Operation Assistant. The Sales Operation Assistant may be associated with a designated set of skills within the system. Candidates may then be automatically evaluated based on their match with the roll. For example, the candidate Kevin Otero at 902 is an 85% match based on the skills detected for Kevin.

FIG. 6 illustrates one example of a computing device. According to various embodiments, a system 600 suitable for implementing embodiments described herein includes a processor 601, a memory module 603, a storage device 605, an interface 611, and a bus 615 (e.g., a PCI bus or other interconnection fabric.) System 600 may operate as variety of devices such as an application server, a database server, or any other device or service described herein. Although a particular configuration is described, a variety of alternative configurations are possible. The processor 601 may perform operations such as those described herein. Instructions for performing such operations may be embodied in the memory 603, on one or more non-transitory computer readable media, or on some other storage device. Various specially configured devices can also be used in place of or in addition to the processor 601. The interface 611 may be configured to send and receive data packets over a network. Examples of supported interfaces include, but are not limited to: Ethernet, fast Ethernet, Gigabit Ethernet, frame relay, cable, digital subscriber line (DSL), token ring, Asynchronous Transfer Mode (ATM), High-Speed Serial Interface (HSSI), and Fiber Distributed Data Interface (FDDI). These interfaces may include ports appropriate for communication with the appropriate media. They may also include an independent processor and/or volatile RAM. A computer system or computing device may include or communicate with a monitor, printer, or other suitable display for providing any of the results mentioned herein to a user.

FIG. 7 shows a block diagram of an example of an environment 710 that includes an on-demand database service configured in accordance with some implementations. Environment 710 may include user systems 712, network 714, database system 716, processor system 717, application platform 718, network interface 720, tenant data storage 722, tenant data 723, system data storage 724, system data 725, program code 726, process space 728, User Interface (UI) 730, Application Program Interface (API) 732, PL/SOQL 734, save routines 736, application setup mechanism 738, application servers 750-1 through 750-N, system process space 752, tenant process spaces 754, tenant management process space 760, tenant storage space 762, user storage 764, and application metadata 766. Some of such devices may be implemented using hardware or a combination of hardware and software and may be implemented on the same physical device or on different devices. Thus, terms such as “data processing apparatus,” “machine,” “server” and “device” as used herein are not limited to a single hardware device, but rather include any hardware and software configured to provide the described functionality.

An on-demand database service, implemented using system 716, may be managed by a database service provider. Some services may store information from one or more tenants into tables of a common database image to form a multi-tenant database system (MTS). As used herein, each MIS could include one or more logically and/or physically connected servers distributed locally or across one or more geographic locations. Databases described herein may be implemented as single databases, distributed databases, collections of distributed databases, or any other suitable database system. A database image may include one or more database objects. A relational database management system (RDBMS) or a similar system may execute storage and retrieval of information against these objects.

In some implementations, the application platform 18 may be a framework that allows the creation, management, and execution of applications in system 716. Such applications may be developed by the database service provider or by users or third-party application developers accessing the service. Application platform 718 includes an application setup mechanism 738 that supports application developers' creation and management of applications, which may be saved as metadata into tenant data storage 722 by save routines 736 for execution by subscribers as one or more tenant process spaces 754 managed by tenant management process 760 for example. Invocations to such applications may be coded using PL/SOQL 734 that provides a programming language style interface extension to API 732. A detailed description of some PL/SOQL language implementations is discussed in commonly assigned U.S. Pat. No. 7,730,478, titled METHOD AND SYSTEM FOR ALLOWING ACCESS TO DEVELOPED APPLICATIONS VIA A MULTI-TENANT ON-DEMAND DATABASE SERVICE, by Craig Weissman, issued on Jun. 1, 2010, and hereby incorporated by reference in its entirety and for all purposes. Invocations to applications may be detected by one or more system processes. Such system processes may manage retrieval of application metadata 766 for a subscriber making such an invocation. Such system processes may also manage execution of application metadata 766 as an application in a virtual machine.

In some implementations, each application server 750 may handle requests for any user associated with any organization. A load balancing function (e.g., an F5 Big-IP load balancer) may distribute requests to the application servers 750 based on an algorithm such as least-connections, round robin, observed response time, etc. Each application server 750 may be configured to communicate with tenant data storage 722 and the tenant data 723 therein, and system data storage 724 and the system data 725 therein to serve requests of user systems 712. The tenant data 723 may be divided into individual tenant storage spaces 762, which can be either a physical arrangement and/or a logical arrangement of data. Within each tenant storage space 762, user storage 764 and application metadata 766 may be similarly allocated for each user. For example, a copy of a user's most recently used (MRU) items might be stored to user storage 764. Similarly, a copy of MRU items for an entire tenant organization may be stored to tenant storage space 762. A UI 730 provides a user interface and an API 732 provides an application programming interface to system 716 resident processes to users and/or developers at user systems 712.

System 716 may implement a web-based skill training and recommendation system. For example, in some implementations, system 716 may include application servers configured to implement and execute skill training software applications. The application servers may be configured to provide related data, code, forms, web pages and other information to and from user systems 712. Additionally, the application servers may be configured to store information to, and retrieve information from a database system. Such information may include related data, objects, and/or Webpage content. With a multi-tenant system, data for multiple tenants may be stored in the same physical database object in tenant data storage 722, however, tenant data may be arranged in the storage medium(s) of tenant data storage 722 so that data of one tenant is kept logically separate from that of other tenants. In such a scheme, one tenant may not access another tenant's data, unless such data is expressly shared.

Several elements in the system shown in FIG. 7 include conventional, well-known elements that are explained only briefly here. For example, user system 712 may include processor system 712A, memory system 712B, input system 712C, and output system 712D. A user system 712 may be implemented as any computing device(s) or other data processing apparatus such as a mobile phone, laptop computer, tablet, desktop computer, or network of computing devices. User system 12 may run an Internet browser allowing a user (e.g., a subscriber of an MTS) of user system 712 to access, process and view information, pages and applications available from system 716 over network 714. Network 714 may be any network or combination of networks of devices that communicate with one another, such as any one or any combination of a LAN (local area network), WAN (wide area network), wireless network, or other appropriate configuration.

The users of user systems 712 may differ in their respective capacities, and the capacity of a particular user system 712 to access information may be determined at least in part by “permissions” of the the particular user system 712. As discussed herein, permissions generally govern access to computing resources such as data objects, components, and other entities of a computing system, such as a skill training and recommendation system, a social networking system, and/or a CRM database system. “Permission sets” generally refer to groups of permissions that may be assigned to users of such a computing environment. For instance, the assignments of users and permission sets may be stored in one or more databases of System 716. Thus, users may receive permission to access certain resources. A permission server in an on-demand database service environment can store criteria data regarding the types of users and permission sets to assign to each other. For example, a computing device can provide to the server data indicating an attribute of a user (e.g., geographic location, industry, role, level of experience, etc.) and particular permissions to be assigned to the users fitting the attributes. Permission sets meeting the criteria may be selected and assigned to the users. Moreover, permissions may appear in multiple permission sets. In this way, the users can gain access to the components of a system.

In some an on-demand database service environments, an Application Programming Interface (API) may be configured to expose a collection of permissions and their assignments to users through appropriate network-based services and architectures, for instance, using Simple Object Access Protocol (SOAP) Web Service and Representational State Transfer (REST) APIs.

In some implementations, a permission set may be presented to an administrator as a container of permissions. However, each permission in such a permission set may reside in a separate API object exposed in a shared API that has a child-parent relationship with the same permission set object. This allows a given permission set to scale to millions of permissions for a user while allowing a developer to take advantage of joins across the API objects to query, insert, update, and delete any permission across the millions of possible choices. This makes the API highly scalable, reliable, and efficient for developers to use.

In some implementations, a permission set API constructed using the techniques disclosed herein can provide scalable, reliable, and efficient mechanisms for a developer to create tools that manage a user's permissions across various sets of access controls and across types of users. Administrators who use this tooling can effectively reduce their time managing a user's rights, integrate with external systems, and report on rights for auditing and troubleshooting purposes. By way of example, different users may have different capabilities with regard to accessing and modifying application and database information, depending on a user's security or permission level, also called authorization. In systems with a hierarchical role model, users at one permission level may have access to applications, data, and database information accessible by a lower permission level user, but may not have access to certain applications, database information, and data accessible by a user at a higher permission level.

As discussed above, system 716 may provide on-demand database service to user systems 712 using an MIS arrangement. By way of example, one tenant organization may be a company that employs a sales force where each salesperson uses system 716 to manage their sales process. Thus, a user in such an organization may maintain contact data, leads data, customer follow-up data, performance data, goals and progress data, etc., all applicable to that user's personal sales process (e.g., in tenant data storage 722). In this arrangement, a user may manage his or her sales efforts and cycles from a variety of devices, since relevant data and applications to interact with (e.g., access, view, modify, report, transmit, calculate, etc.) such data may be maintained and accessed by any user system 712 having network access,

When implemented in an MIS arrangement, system 716 may separate and share data between users and at the organization-level in a variety of manners. For example, for certain types of data each user's data might be separate from other users' data regardless of the organization employing such users. Other data may be organization-wide data, which is shared or accessible by several users or potentially all users form a given tenant organization. Thus, some data structures managed by system 716 may be allocated at the tenant level while other data structures might be managed at the user level. Because an MTS might support multiple tenants including possible competitors, the MTS may have security protocols that keep data, applications, and application use separate. In addition to user-specific data and tenant-specific data, system 716 may also maintain system-level data usable by multiple tenants or other data. Such system-level data may include industry reports, news, postings, and the like that are sharable between tenant organizations.

In some implementations, user systems 712 may be client systems communicating with application servers 750 to request and update system-level and tenant-level data from system 716. By way of example, user systems 712 may send one or more queries requesting data of a database maintained in tenant data storage 722 and/or system data storage 724. An application server 750 of system 716 may automatically generate one or more SQL statements (e.g., one or more SQL queries) that are designed to access the requested data. System data storage 724 may generate query plans to access the requested data from the database.

The database systems described herein may be used for a variety of database applications. By way of example, each database can generally be viewed as a collection of objects, such as a set of logical tables, containing data fitted into predefined categories. A “table” is one representation of a data object, and may be used herein to simplify the conceptual description of objects and custom objects according to some implementations. It should be understood that “table” and “object” may be used interchangeably herein. Each table generally contains one or more data categories logically arranged as columns or fields in a viewable schema. Each row or record of a table contains an instance of data for each category defined by the fields. For example, a CRM database may include a table that describes a customer with fields for basic contact information such as name, address, phone number, fax number, etc. Another table might describe a purchase order, including fields for information such as customer, product, sale price, date, etc. In some multi-tenant database systems, standard entity tables might be provided for use by all tenants. For CRM database applications, such standard entities might include tables for case, account, contact, lead, and opportunity data objects, each containing pre-defined fields. It should be understood that the word “entity” may also be used interchangeably herein with “object” and “table”.

In some implementations, tenants may be allowed to create and store custom objects, or they may be allowed to customize standard entities or objects, for example by creating custom fields for standard objects, including custom index fields. Commonly assigned U.S. Pat. No. 7,779,039, titled CUSTOM ENTITIES AND FIELDS IN A MULTI-TENANT DATABASE SYSTEM, by Weissman et al., issued on Aug. 17, 2010, and hereby incorporated by reference in its entirety and for all purposes, teaches systems and methods for creating custom objects as well as customizing standard objects in an MTS. In certain implementations, for example, all custom entity data rows may be stored in a single multi-tenant physical table, which may contain multiple logical tables per organization. It may be transparent to customers that their multiple “tables” are in fact stored in one large table or that their data may be stored in the same table as the data of other customers.

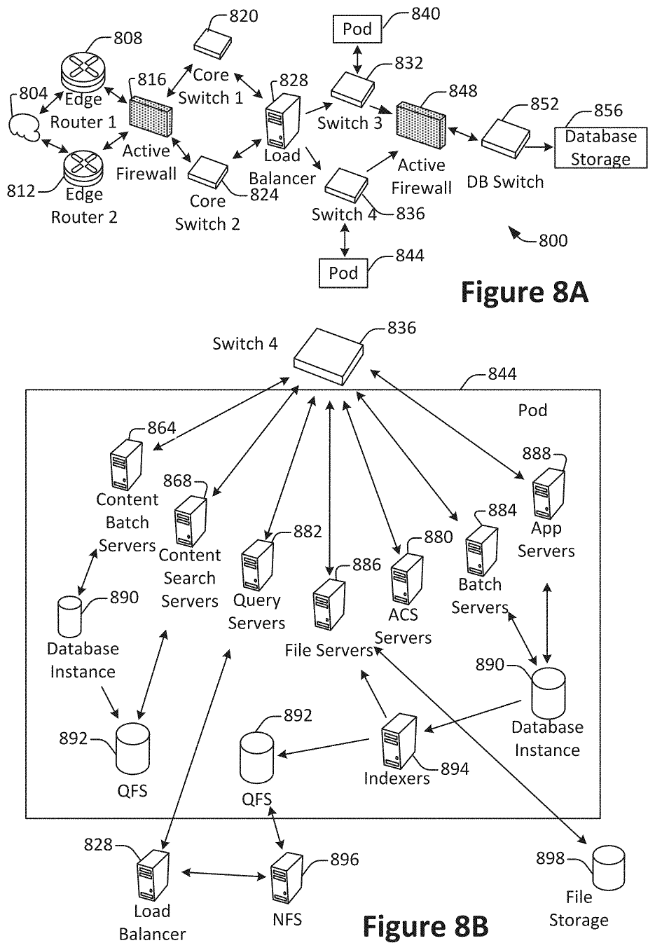

FIG. 8A shows a system diagram of an example of architectural components of an on-demand database service environment 800, configured in accordance with some implementations. A client machine located in the cloud 804 may communicate with the on-demand database service environment via one or more edge routers 808 and 812. A client machine may include any of the examples of user systems ?12 described above. The edge routers 808 and 812 may communicate with one or more core switches 820 and 824 via firewall 816. The core switches may communicate with a load balancer 828, which may distribute server load over different pods, such as the pods 840 and 844 by communication via pod switches 832 and 836. The pods 840 and 844, which may each include one or more servers and/or other computing resources, may perform data processing and other operations used to provide on-demand services. Components of the environment may communicate with a database storage 856 via a database firewall 848 and a database switch 852,

Accessing an on-demand database service environment may involve communications transmitted among a variety of different components. The environment 800 is a simplified representation of an actual on-demand database service environment, For example, some implementations of an on-demand database service environment may include anywhere from one to many devices of each type. Additionally, an on-demand database service environment need not include each device shown, or may include additional devices not shown, in FIGS. 8A and 8B.

The cloud 804 refers to any suitable data network or combination of data networks, which may include the Internet, Client machines located in the cloud 804 may communicate with the on-demand database service environment 800 to access services provided by the on-demand database service environment 800. By way of example, client machines may access the on-demand database service environment 800 to retrieve, store, edit, and/or process skill training and observed experience information.

In some implementations, the edge routers 808 and 812 route packets between the cloud 804 and other components of the on-demand database service environment 800. The edge routers 808 and 812 may employ the Border Gateway Protocol (BGP). The edge routers 808 and 812 may maintain a table of IP networks or ‘prefixes’, which designate network reachability among autonomous systems on the Internet.

In one or more implementations, the firewall 816 may protect the inner components of the environment 800 from Internet traffic. The firewall 816 may block, permit, or deny access to the inner components of the on-demand database service environment 800 based upon a set of rules and/or other criteria, The firewall 816 may act as one or more of a packet filter, an application gateway, a stateful filter, a proxy server, or any other type of firewall.

In some implementations, the core switches 820 and 824 may be high-capacity switches that transfer packets within the environment 800. The core switches 820 and 824 may be configured as network bridges that quickly route data between different components within the on-demand database service environment. The use of two or more core switches 820 and 824 may provide redundancy and/or reduced latency.

In some implementations, communication between the pods 840 and 844 may be conducted via the pod switches 832 and 836. The pod switches 832 and 836 may facilitate communication between the pods 840 and 844 and client machines, for example via core switches 820 and 824. Also or alternatively, the pod switches 832 and 836 may facilitate communication between the pods 840 and 844 and the database storage 856. The load balancer 828 may distribute workload between the pods, which may assist in improving the use of resources, increasing throughput, reducing response times, and/or reducing overhead. The load balancer 828 may include multilayer switches to analyze and forward traffic.

In some implementations, access to the database storage 856 may be guarded by a database firewall 848, which may act as a computer application firewall operating at the database application layer of a protocol stack, The database firewall 848 may protect the database storage 856 from application attacks such as structure query language (SQL) injection, database rootkits, and unauthorized information disclosure. The database firewall 848 may include a host using one or more forms of reverse proxy services to proxy traffic before passing it to a gateway router and/or may inspect the contents of database traffic and block certain content or database requests. The database firewall 848 may work on the SQL application level atop the TCP/IP stack, managing applications' connection to the database or SQL management interfaces as well as intercepting and enforcing packets traveling to or from a database network or application interface.

In some implementations, the database storage 856 may be an on-demand database system shared by many different organizations. The on-demand database service may employ a single-tenant approach, a multi-tenant approach, a virtualized approach, or any other type of database approach. Communication with the database storage 856 may be conducted via the database switch 852. The database storage 856 may include various software components for handling database queries. Accordingly, the database switch 852 may direct database queries transmitted by other components of the environment (e.g., the pods 840 and 844) to the correct components within the database storage 856.

FIG. 8B shows a system diagram further illustrating an example of architectural components of an on-demand database service environment, in accordance with some implementations. The pod 844 may be used to render services to user(s) of the on-demand database service environment 800. The pod 844 may include one or more content batch servers 864, content search servers 868, query servers 882, file servers 886, access control system (ACS) servers 880, batch servers 884, and app servers 888. Also, the pod 844 may include database instances 890, quick file systems (QFS) 892, and indexers 894. Some or all communication between the servers in the pod 844 may be transmitted via the switch 836.

In some implementations, the app servers 888 may include a framework dedicated to the execution of procedures (e.g., programs, routines, scripts) for supporting the construction of applications provided by the on-demand database service environment 800 via the pod 844. One or more instances of the app server 888 may be configured to execute all or a portion of the operations of the services described herein.

In some implementations, as discussed above, the pod 844 may include one or more database instances 890, A database instance 890 may be configured as an MIS in which different organizations share access to the same database, using the techniques described above. Database information may be transmitted to the indexer 894, which may provide an index of information available in the database 890 to file servers 886. The QFS 892 or other suitable filesystem may serve as a rapid-access file system for storing and accessing information available within the pod 844. The QFS 892 may support volume management capabilities, allowing many disks to be grouped together into a file system. The QFS 892 may communicate with the database instances 890, content search servers 868 and/or indexers 894 to identify, retrieve, move, and/or update data stored in the network file systems (NFS) 896 and/or other storage systems.

In some implementations, one or more query servers 882 may communicate with the NFS 896 to retrieve and/or update information stored outside of the pod 844, The NFS 896 may allow servers located in the pod 844 to access information over a network in a manner similar to how local storage is accessed. Queries from the query servers 822 may be transmitted to the NFS 896 via the load balancer 828, which may distribute resource requests over various resources available in the on-demand database service environment 800. The NFS 896 may also communicate with the QFS 892 to update the information stored on the NFS 896 and/or to provide information to the QFS 892 for use by servers located within the pod 844.

In some implementations, the content batch servers 864 may handle requests internal to the pod 844. These requests may be long-running and/or not tied to a particular customer, such as requests related to log mining, cleanup work, and maintenance tasks. The content search servers 868 may provide query and indexer functions such as functions allowing users to search through content stored in the on-demand database service environment 800. The file servers 886 may manage requests for information stored in the file storage 898, which may store information such as documents, images, basic large objects (BLOBS), etc. The query servers 882 may be used to retrieve information from one or more file systems. For example, the query system 882 may receive requests for information from the app servers 888 and then transmit information queries to the NFS 896 located outside the pod 844. The ACS servers 880 may control access to data, hardware resources, or software resources called upon to render services provided by the pod 844. The batch servers 884 may process batch jobs, which are used to run tasks at specified times. Thus, the batch servers 884 may transmit instructions to other servers, such as the app servers 888, to trigger the batch jobs.

While some of the disclosed implementations may be described with reference to a system having an application server providing a front end for an on-demand database service capable of supporting multiple tenants, the disclosed implementations are not limited to multi-tenant databases nor deployment on application servers. Some implementations may be practiced using various database architectures such as ORACLE®, DB2® by IBM and the like without departing from the scope of present disclosure.

Any of the disclosed implementations may be embodied in various types of hardware, software, firmware, computer readable media, and combinations thereof. For example, some techniques disclosed herein may be implemented, at least in part, by computer-readable media that include program instructions, state information, etc., for configuring a computing system to perform various services and operations described herein. Examples of program instructions include both machine code, such as produced by a compiler, and higher-level code that may be executed via an interpreter. Instructions may be embodied in any suitable language such as, for example, Apex, Java, Python, C++, C, HTML, any other markup language, JavaScript, ActiveX, VBScript, or Perl. Examples of computer-readable media include, but are not limited to: magnetic media such as hard disks and magnetic tape; optical media such as flash memory, compact disk (CD) or digital versatile disk (DVD); magneto-optical media; and other hardware devices such as read-only memory (“ROM”) devices and random-access memory (“RAM”) devices. A computer-readable medium may be any combination of such storage devices.

In the foregoing specification, various techniques and mechanisms may have been described in singular form for clarity. However, it should be noted that some embodiments include multiple iterations of a technique or multiple instantiations of a mechanism unless otherwise noted. For example, a system uses a processor in a variety of contexts but can use multiple processors while remaining within the scope of the present disclosure unless otherwise noted. Similarly, various techniques and mechanisms may have been described as including a connection between two entities. However, a connection does not necessarily mean a direct, unimpeded connection, as a variety of other entities (e.g., bridges, controllers, gateways, etc.) may reside between the two entities.

In the foregoing specification, reference was made in detail to specific embodiments including one or more of the best modes contemplated by the inventors. While various implementations have been described herein, it should be understood that they have been presented by way of example only, and not limitation. For example, some techniques and mechanisms are described herein in the context of on-demand computing environments that include MISs. However, the techniques of the present invention apply to a wide variety of computing environments. Particular embodiments may be implemented without some or all of the specific details described herein. In other instances, well known process operations have not been described in detail in order not to unnecessarily obscure the present invention. Accordingly, the breadth and scope of the present application should not be limited by any of the implementations described herein, but should be defined only in accordance with the claims and their equivalents.

1. A method comprising:
identifying via a processor a designated plurality of skill ratings associated with a user account in an on-demand computing services environment, the on-demand computing services environment providing a plurality of computing services to a plurality of clients via the Internet, the user account being authorized to perform one or more actions related to a first one of the plurality of clients within the on-demand computing services environment, the on-demand computing services environment being associated with a plurality of skills, each skill identifying the use of a respective one or more features of the on-demand computing services environment, each skill rating indicating an estimated ability level associated with a respective one of the plurality of skills;
determining a recommendation profile for the user account based on the designated skill ratings and a skill graph, the skill graph indicating a plurality of dependency relationships between the plurality of skills, the skill graph associating different subsets of the skills with different career objectives, the recommendation profile identifying one or more training modules to be completed in association with the user account, each of the training modules including a course of action to take to increase one or more of the designated skill ratings to reach one or more of the career objectives; and
transmitting a recommendation message to a client machine, the recommendation message including one or more recommendations selected from the recommendation profile for presentation in a user interface at the client machine.

2. The method recited in claim 1, wherein identifying the skill ratings comprises retrieving information from a social media profile associated with the user account.

3. The method recited in claim 1, wherein identifying the skill ratings comprises analyzing one or more actions performed within the on-demand computing services environment by the user account.

4. The method recited in claim 1, wherein identifying the skill ratings comprises identifying one or more instructional courses completed in association with the user account.

5. The method recited in claim 1, wherein the user account is authorized to perform actions within the on-demand computing services environment related to a second one of the plurality of clients.

6. The method recited in claim 1, wherein a designated one of the training modules includes an instructional training course accessible via the on-demand computing services environment.

7. The method recited in claim 1, wherein a designated one of the training modules includes a skill examination procedure associated with one or more of the skill ratings, the skill examination procedure evaluating one or more of the ability levels, the skill examination procedure capable of being completed via the on-demand computing services environment.

8. The method recited in claim 1, wherein a designated one of the training modules includes one or more actions to perform related to one or more services provided to the first client via the on-demand computing services environment.

9. The method recited in claim 1, wherein dependency relationship identifies a respective first skill that is a precursor to a respective second skill.

10. The method recited in claim 1, wherein determining the recommendation profile includes determining a difference between the designated skill ratings and a targeted plurality of skill ratings, the targeted skill ratings being associated with one or more of the career objectives.

11. The method recited in claim 1, wherein the on-demand computing services environment is configured to provide customer relations management services to a plurality of clients.

12. The method recited in claim 1, wherein each of the plurality of clients is a tenant in a multitenant database system accessible via the on-demand computing services environment.

13. An on-demand computing services environment implemented using a server system, the on-demand computing services system configurable to perform a method comprising:
identifying via a processor a designated plurality of skill ratings associated with a user account in the on-demand computing services environment, the on-demand computing services environment providing a plurality of computing services to a plurality of clients via the internet, the user account being authorized to perform one or more actions related to a first one of the plurality of clients within the on-demand computing services environment, the on-demand computing services environment being associated with a plurality of skills, each skill identifying the use of a respective one or more features of the on-demand computing services environment, each skill rating indicating an estimated ability level associated with a respective one of the plurality of skills;
determining a recommendation profile for the user account based on the designated skill ratings and a skill graph, the skill graph indicating a plurality of dependency relationships between the plurality of skills, the skill graph associating different subsets of the skills with different career objectives, the recommendation profile identifying one or more training modules to be completed in association with the user account, each of the training modules including a course of action to take to increase one or more of the designated skill ratings to reach one or more of the career objectives; and
transmitting a recommendation message to a client machine, the recommendation message including one or more recommendations selected from the recommendation profile for presentation in a user interface at the client machine.

14. The on-demand computing services environment recited in claim 13, wherein the user account is authorized to perform actions within the on-demand computing services environment related to a second one of the plurality of clients.

15. The on-demand computing services environment recited in claim 13, wherein dependency relationship identifies a respective first skill that is a precursor to a respective second skill.

16. The on-demand computing services environment recited in claim 13, wherein determining the recommendation profile includes determining a difference between the designated skill ratings and a targeted plurality of skill ratings, the targeted skill ratings being associated with one or more of the career objectives.

17. The on-demand computing services environment recited in claim 13, wherein on-demand computing services environment is configured to provide customer relations management services to a plurality of clients.

18. The on-demand computing services environment recited in claim 13, wherein each of the plurality of clients is a tenant in a database system accessible via the on-demand computing services environment.

19. A computer program product comprising computer-readable program code capable of being executed by one or more processors when retrieved from a non-transitory computer-readable medium, the program code comprising instructions configurable to cause the one or more processors to perform a method comprising:
identifying via a processor a designated plurality of skill ratings associated with a user account in an on-demand computing services environment, the on-demand computing services environment providing a plurality of computing services to a plurality of clients via the internet, the user account being authorized to perform one or more actions related to a first one of the plurality of clients within the on-demand computing services environment, the on-demand computing services environment being associated with a plurality of skills, each skill identifying the use of a respective one or more features of the on-demand computing services environment, each skill rating indicating an estimated ability level associated with a respective one of the plurality of skills;
determining a recommendation profile for the user account based on the designated skill ratings and a skill graph, the skill graph indicating a plurality of dependency relationships between the plurality of skills, the skill graph associating different subsets of the skills with different career objectives, the recommendation profile identifying one or more training modules to be completed in association with the user account, each of the training modules including a course of action to take to increase one or more of the designated skill ratings to reach one or more of the career objectives; and
transmitting a recommendation message to a client machine, the recommendation message including one or more recommendations selected from the recommendation profile for presentation in a user interface at the client machine.

20. The on-demand computing services environment recited in claim 19, wherein the user account is authorized to perform actions within the on-demand computing services environment related to a second one of the plurality of clients.
